(19) United States
(12) Patent Application Publication
(10) Pub. No.: US 2024/0188761 A1
(43) Pub. Date: Jun. 13, 2024

(54) PORTABLE SHOWER APPARATUS

(71) Applicant: Harrison FULLARD, Monavale (AU)

(72) Inventor: Harrison FULLARD, Monavale (AU)

(21) Appl. No.: 18/554,877

(22) PCT Filed: Apr. 22, 2022
(86) PCT No.: PCT/AU2022/050370

§ 371 Date: Oct. 11, 2023

(30) Foreign Application Priority Data
May 5, 2021 (AU) 2021901340

(51) Int. Cl. A47K 3/28; F24H 1/06; F24H 1/20

(52) U.S. Cl. CPC A47K 3/288; F24H 1/06; F24H 1/20

(57) ABSTRACT

Portable shower apparatus comprises a sealed water container a fill port through the container an outlet and a pump. The pump pumps water from within the container via the outlet.

### FIELD OF THE INVENTION

This invention relates generally to a portable shower apparatus preferably for the off-road vehicle industry.

### SUMMARY OF THE DISCLOSURE

There is provided herein a portable shower apparatus comprising a sealed water container, a fill port through the container and outlet and a pump. In use, the pump pumps water from within the container via the outlet.

Aspects of the apparatus disclosed herein have features of shape and configuration which aid the usability and durability of the apparatus, especially when used with off-road vehicles.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a side elevation view of portable shower apparatus in accordance with an embodiment;

FIG. 2 shows a top view of the apparatus of FIG. 1;

FIG. 3 shows a perspective end view of the apparatus of FIG. 1;

FIG. 4 shows an opposite perspective end of the apparatus of FIG. 1;

FIG. 5 shows a perspective end view of the apparatus of FIG. 1 with a hose attached thereto;

FIG. 6 shows internals of the apparatus of FIG. 1; and

FIG. 7 illustrates the storage of the apparatus within a holding cage in accordance with an embodiment.

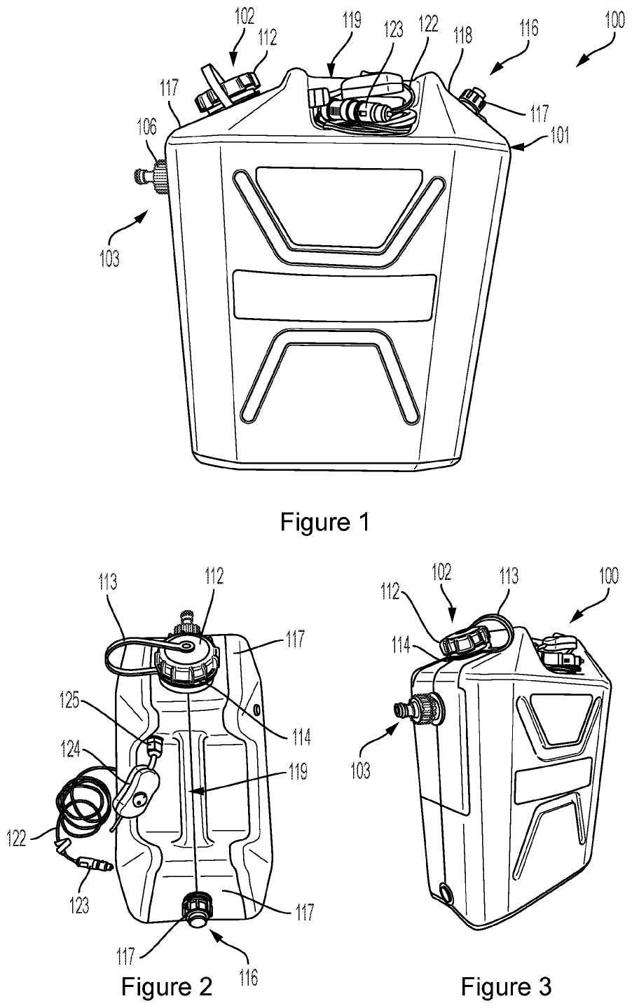

### DESCRIPTION OF EMBODIMENTS

A portable shower apparatus 100 comprises a sealed water container 101, a fill port 102 through the container 101 and outlet 103 and a pump 104. In use, the pump 104 pumps water from within the container 101 via the outlet 103.

In the embodiment shown, the container 101 is plastic.

The container 110 preferably comprises a rectangular horizontal cross-section. The horizontal cross-section may have a length more than twice a width thereof. The width may be between 140 and 180 mm, preferably approximately 165 mm. Furthermore, the length may be between 300 mm and 370 mm, preferably approximately 345 mm.

The container 101 may comprise a height greater than a length of the rectangular horizontal cross-section. The height may be between 450 mm and 490 mm, preferably approximately 468 mm.

Referencing FIG. 7, the container 101 is preferably configured to fit within a cage 105, the cage 105 being open at an upper end thereof. The cage may comprise a length greater than 300 mm, such as approximately 370 mm. Furthermore, the cage may comprise a width of greater than 140 mm, such as approximately 200 mm. Furthermore, the cage 105 may comprise a depth of approximately 300 mm.

The outlet 103 preferably locates so as to be exposed when the container 101 is held within the cage 105. In this regard, the outlet 103 preferably locates at an upper half of the container 101. The outlet 103 may locate more than 300 mm above a bottom of the container 101.

The fill port 102 may also locate at an upper half of the container 101 so as to be exposed for utilisation when the container 101 locates within the cage 105.

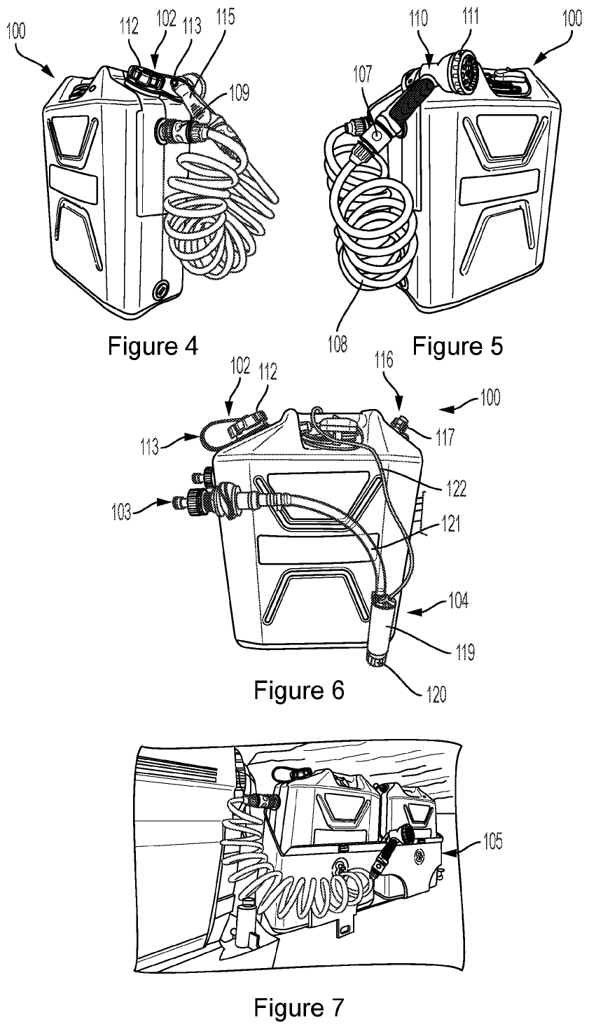

In embodiments shown, the outlet 103 comprises a hose coupling 106 for releasable coupling to a hose connector 109 of a hose 108 in use. As shown in FIGS. 4 and 5, the hose 108 may be coiled. A distal end of the hose 108 may comprise a further hose coupling 107 for releasable attachment to a spray gun 110. The spray gun 110 may comprise a rotary dial 111 for differing spray effects in use.

The hose coupling 106 is preferably a male-type hose coupling and wherein the connector 109 is a female-type connector which receives the male-type hose coupling 106 therein. The connector 109 may comprise a snap fit connection comprising a displaceable collar which may be pulled to connect to the hose coupling 106 and subsequently released to engage the coupling 106 in a water tight manner.

The fill port 102 may comprise a diameter of greater than 50 mm.

The apparatus 100 may further comprise a screw cap 112 engageable to screw threading of the fill port 102. The apparatus 100 may comprise a tether 113 engaging the screw cap 112 to the fill port 102. As shown in FIG. 2, the tether 113 engage an outer surface of the screw cap 112 coaxially and comprise an annulus 114 engaging around the fill port. As illustrated in FIG. 4, a handle 115 of the spray gun 110 may be held through the tether 113.

The apparatus 100 may further comprise an air inlet 116 through the container 101. The air inlet 116 may similarly preferably be located at an upper half of the container 101. Specifically, the air inlet 116 may locate more than 300 mm above a bottom of the container 101. The air inlet 116 may comprise a knob 117 which may be turned in one direction to close the air inlet 116 and turned in an opposite direction to open the air inlet 116.

The container 101 may define an integrally formed handle 116 across a top thereof. The handle 116 may be centrally located and may define an adjacent sloped surface 117 with the fill port 102 therethrough. The handle 116 may further define a further adjacent sloped surface 118 with the air inlet 116 therethrough. As such, the fill port 102 and/or the air inlet 116 may be protected away from sides of the container.

As shown in FIG. 6, the pump 104 may be permanently located within the water container 101. The pump 104 is preferably a submerged pump comprising a weighted body 119 having an inlet 120 at a lower end thereof. The submerged pump 119 may be connected to the outlet via a delivery hose 121. The submerged pump body 119 may be free to move within the container 101 to locate at a bottom of the container 101 to be able to draw water right to the bottom of the container 101.

The pump 104 is preferably an 12v electric pump and the apparatus 100 may further comprise a power source for the electric pump 104. In one embodiment, the power source comprises a rechargeable battery supply (not shown). The battery supply may be located within the container 101 in embodiments.

However, in embodiments shown, the apparatus 100 comprises an electrical lead 122 going through the container 101 and electrically connected to the electric pump 104. The electrical lead 122 may comprise an electric plug 123 at a proximal end thereof. The electric plug 123 may comprise a 12 V cigarette lighter plug for drawing electrical power from a 12 V cigarette outlet of a vehicle. The apparatus 100 may further comprise an electric switch 123. As shown in FIG. 2, the electric switch 123 may interface the electrical lead 122. The electric switch 123 may be a rocker-type on/off switch to turn the pump 104 on or off.

As further shown in FIG. 2, the electrical lead 122 may go through the water container 101 at an electrical connection 125. In embodiments, the electrical connections 125 may be unplugged to stow the electrical lead 122 when not in use.

As is further shown, the electrical lead 122 may go through the container 101 adjacent the handle 116 so as to be protected thereby.

In embodiments, the apparatus 100 may comprise a rechargeable battery within the container 101 which powers the electric pump 104 but which may be periodically recharged using the electrical lead 122. In embodiments, the electrical pump 119 may comprise a power controller which draws electric power via the electrical lead 122 when available or alternatively draw power from the rechargeable battery.

In embodiments, the apparatus 100 may comprise a heater element located within the container to heat water therein. The heater element may draw power from an AC or DC supply where available. The apparatus 100 may comprise a separate electrical lead to connect the heater element to a general power outlet where available.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. Portable shower apparatus comprising: a sealed water container; a fill port through the container; an outlet and a pump which, in use, pumps water from within the container via the outlet.

2. Apparatus as claimed in claim 1, wherein the container comprises a rectangular horizontal cross-section.

3. Apparatus as claimed in claim 2, wherein the rectangular horizontal cross-section has a length more than twice a width thereof.

4. Apparatus as claimed in claim 3, wherein the width is between 140 and 180 mm.

5. Apparatus as claimed in claim 3, wherein the width is approximately 165 mm.

6. Apparatus as claimed in claim 3, wherein the length is between 330 millimetres and 370 mm.

7. Apparatus as claimed in claim 3, wherein the length is approximately 345 mm.

8. Apparatus as claimed in claim 2, wherein the container comprises a height greater than a length of the rectangular horizontal cross-section.

9. Apparatus as claimed in claim 8, wherein the height is between 450 mm and 490 mm.

10. Apparatus as claimed in claim 8, wherein light is approximately 468 mm.

11. Apparatus as claimed in claim 1, wherein the container is configured to fit within a cage being open at an upper end thereof.

12. Apparatus as claimed in claim 11, wherein the cage comprises a length greater than 330 mm.

13. Apparatus as claimed in claim 11, wherein the catch comprises a length of approximately 370 mm.

14. Apparatus as claimed in claim 11, wherein the cage comprises a width of greater than 140 mm.

15. Apparatus as claimed in claim 11, wherein the cage comprises a width of approximately 200 mm.

16. Apparatus as claimed in claim 11, wherein the cage comprises a depth of approximately 300 mm.

17. Apparatus as claimed in claim 16, wherein outlet locates more than 300 mm above a bottom of the container.

18. Apparatus as claimed in claim 11, further comprising the cage as claimed in any one of claims 11-17.

19. Apparatus as claimed in claim 1, wherein the outlet comprises a hose coupling for releasable coupling to a hose connector of a hose in use.

20. Apparatus as claimed in claim 19, further comprising the hose and the connector.

21. Apparatus as claimed in claim 19, wherein the hose coupling is a male-type hose coupling.

22. Apparatus as claimed in claim 21, further comprising the hose and the connector and wherein the connector is a female type connector which receives the male-type hose coupling therein.

23. Apparatus as claimed in claim 22, wherein the connector comprises a snap fit connection comprising a displaceable collar.

24. Apparatus as claimed in claim 1, wherein the fill port comprises a diameter of greater than 50 mm.

25. Apparatus as claimed in claim 1, further comprising a screw cap engageable to screw threading of the fill port.

26. Apparatus as claimed in claim 25, further comprising a tether engaging the screw cap to the fill port.

27. Apparatus as claimed in claim 26, wherein the tether engages an outer surface of the screw cap coaxially and comprises an annulus engaging around the fill port.

28. Apparatus as claimed in claim 1, further comprising an air inlet through the container.

29. Apparatus as claimed in claim 28, wherein the air inlet is located at an upper half of the container.

30. Apparatus as claimed in claim 28, wherein outlet locates more than 300 mm above a bottom of the container.

31. Apparatus as claimed in claim 1, wherein the container defines an integrally formed handle across a top thereof.

32. Apparatus as claimed in claim 31, wherein the handle is centrally located and defines an adjacent sloped surface and wherein the fill port is through the sloped surface.

33. Apparatus as claimed in claim 32, wherein the handle is centrally located and defines an adjacent sloped surface and wherein the apparatus further comprises an air inlet through the sloped surface.

34. Apparatus as claimed in claim 1, wherein the pump is located within the water container.

35. Apparatus as claimed in claim 34, wherein the pump is a submerged pump connected to the outlet via a delivery hose.

36. Apparatus as claimed in claim 35, wherein the submerged pump is free to move within the container to locate at bottom of the container.

37. Apparatus as claimed in claim 34, wherein the pump is an electric pump and wherein the apparatus further comprises a power source for the electric pump.

38. Apparatus as claimed in claim 37, further comprising an electrical lead going through the container and electrically connected to the electric pump.

39. Apparatus as claimed in claim 38, wherein the electrical lead comprises an electric plug at a proximal end thereof.

40. Apparatus as claimed in claim 39, wherein the electric plug as a 12 V cigarette lighter plug.

41. Apparatus as claimed in claim 38, wherein the electrical lead comprises an electric switch.

42. Apparatus as claimed in claim 38, wherein the electrical lead goes through the water container at an electrical connection and wherein the electrical connection can be unplugged.

43. Apparatus as claimed in claim 38, wherein the container defines an integrally formed handle across a top thereof and wherein the electrical lead goes through the container adjacent the handle.

44. Apparatus as claimed in claim 20, further comprising a spray gun at a proximal end of the hose.

45. Apparatus as claimed in claim 44, wherein the spray gun comprises a rotary dial for differing spray effects in use.

46. Apparatus as claimed in claim 44, wherein the spray gun is attachable to the proximal end of the hose and a releasable coupling.

47. Apparatus as claimed in claim 1, further comprising a heater element located within the container.

48. Apparatus as claimed in claim 47, wherein the heater element draws power from an AC supply.

49. Apparatus as claimed in claim 48, wherein the apparatus comprises an AC electrical lead to connect the heater element to an AC power outlet in use.

50. Apparatus as claimed in claim 28, wherein the air inlet comprises a knob which can be turned in one direction to close the air inlet and turned in an opposite direction to open the air inlet.

51. Apparatus as claimed in claim 38, further comprising a rechargeable battery which powers the electric pump and which may be periodically recharged using the electrical lead.

52. Apparatus as claimed in claim 51, wherein the apparatus comprises a power controller which draws electric power via the electrical lead when available or alternatively draws power from the rechargeable battery.
